(19) United States
(12) Patent Application Publication
(10) Pub. No.: US 2012/0192902 A1
(43) Pub. Date: Aug. 2, 2012

(54) PET WASTE REMOVAL DEVICE

(76) Inventor: Lawrence Orubor, Calgary (CA)

(21) Appl. No.: 13/500,173

(22) PCT Filed: Oct. 27, 2010
(86) PCT No.: PCT/IB10/54864

§ 371 Date: Apr. 4, 2012

Related U.S. Application Data
(60) Provisional application No. 61/255,944, filed on Oct. 29, 2009.

(51) Int. Cl. B08B 3/00

(52) U.S. Cl. 134/115 R

(57) ABSTRACT

A pet waste removal device including an elongated hand held boom having an open bottom shield disposed at a bottom end of the boom for positioning over a pile of animal waste. A motor driven agitator is disposed within the shield and driven by a motor to reciprocate to mechanically break up pet waste. Fluid jet nozzles are supplied water via a garden hose connection and are arranged to direct water jets into the shield to wash away the pet waste as it is broken up by the agitator. A chemical dispenser for dispensing a treatment solution is also provided.

### FIELD OF THE INVENTION

The present invention relates generally to pet waste removal devices, and more particularly, relating to a pet waste removal and disinfecting device for the removal of solid pet waste from a surface by a combination of powered agitation and treatment solution jet action.

### BACKGROUND OF THE INVENTION

Animal waste, particularly raw fecal material from dogs and other household pets are smelly and consist largely of numerous disease causing pathogens that pose potential health risks to pets and humans exposed to them. These disease causing pathogens found in fecal material also contaminated our soil, water and food grown in their vicinity. It is believed, the enormous volume of uncontrolled animal waste produced each year has significant impact on public health and the environment. Particularly, in the presence of accumulated waste in places such as backyards, public and private play grounds, including off leash parks. The presence of animal waste is considered an eye sore and a nuisance which must be eliminated.

### SUMMARY OF THE INVENTION

The preferred embodiments of the present invention addresses this need by providing a pet waste removal device that has an improved construction affording a combination of powered agitation and treatment solution flushing action to dispose of pet waste.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a diagrammatic, and partial cross-sectional, side elevation view of a first embodiment of a pet waste removal device constructed in accordance with the principles of the invention;

FIG. 2 is a is a diagrammatic bottom view of an agitator of the pet waste removal device;

FIG. 3 is a is a diagrammatic side view of the agitator;

FIG. 4 is a block diagram of an exemplarily electrical circuit comprising a power supply, a motor, a pump, a first electrical switch, a second electrical switch, third electrical switch, and a fourth electrical switch;

FIG. 5 is the pet waste removal device of FIG. 1 shown in one mode of operation where an on-board chemical dispenser unit is being filled by supply water connected to the pet waste removal device;

FIG. 6 is the pet waste removal device of FIG. 1 shown in a second mode of operation where the pet waste removal device is being operated to clean, sanitize and remove pet waste from a surface;

FIG. 7 is the pet waste removal device of FIG. 1 shown in a third mode of operation where the pet waste removal device is being operated in a “self-clean” mode to clean, sanitize and remove any residual pet waste from the device;

FIG. 8 is a diagrammatic, and partial cross-sectional, side elevation view of a second embodiment of a pet waste removal device constructed in accordance with the principles of the invention;

FIG. 9 is diagrammatic, and partial cross-sectional, side elevation view of a third embodiment of a pet waste removal device constructed in accordance with the principles of the invention;

FIG. 10 is an enlarged, diagrammatic, and partial cross-sectional, side elevation view of a fourth embodiment of a pet waste removal device constructed in accordance with the principles of the invention;

FIG. 11 is diagrammatic, and partial cross-sectional, side elevation view of a fifth embodiment of a pet waste removal device constructed in accordance with the principles of the invention;

FIG. 12 is a block diagram of an exemplarily electrical circuit of the fifth embodiment of the pet waste removal device of FIG. 11;

FIG. 13 is diagrammatic, and partial cross-sectional, side elevation view of a sixth embodiment of a pet waste removal device constructed in accordance with the principles of the invention;

FIG. 14 is a block diagram of an exemplarily electrical circuit of the sixth embodiment of the pet waste removal device of FIG. 13;

FIG. 15 is diagrammatic, and partial cross-sectional, side elevation view of a seventh embodiment of a pet waste removal device constructed in accordance with the principles of the invention;

FIG. 16 is diagrammatic, and partial cross-sectional, side elevation view of a eighth embodiment of a pet waste removal device constructed in accordance with the principles of the invention;

FIG. 17 is diagrammatic, and partial cross-sectional, side elevation view of a ninth embodiment of a pet waste removal device constructed in accordance with the principles of the invention;

FIG. 18 is diagrammatic, and partial cross-sectional, side elevation view of a tenth embodiment of a pet waste removal device constructed in accordance with the principles of the invention;

FIG. 19 is an enlarged, diagrammatic, and partial cross-sectional, side elevation view of an eleventh embodiment of a pet waste removal device constructed in accordance with the principles of the invention in a first configured operation;

FIG. 20 is an enlarged, diagrammatic, and partial cross-sectional, side elevation view of an eleventh embodiment of a pet waste removal device constructed in accordance with the principles of the invention in a second configured operation;

FIG. 21 is an enlarged, diagrammatic, and partial cross-sectional, side elevation view of an twelfth embodiment of a pet waste removal device constructed in accordance with the principles of the invention in a second configured operation; and

FIG. 22 is a block diagram of an exemplarily electrical circuit of the twelfth embodiment of the pet waste removal device of FIG. 21.

### DETAILED DESCRIPTION OF THE INVENTION

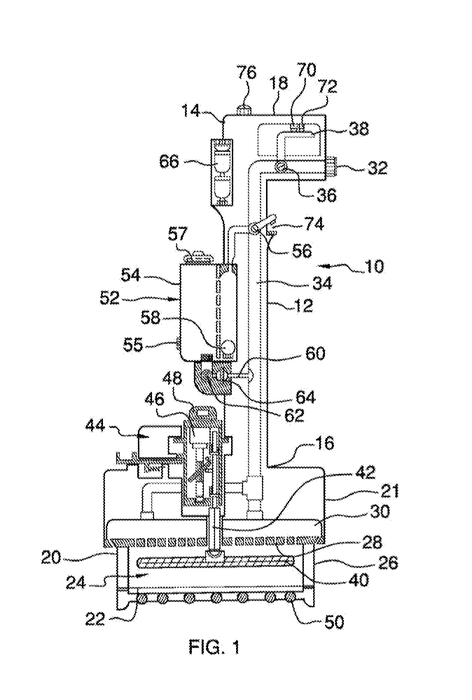

FIG. 1 is a diagrammatic, and partial cross-sectional, side elevation view of a first embodiment of a pet waste removal device 10 of the present invention. The pet waste removal device 10 is useful in the sanitizing and the disposal of animal waste, as will be come readily apparent from this disclosure. The pet waste removal device 10 includes an elongated boom 12 having an upper or first end 14 and lower or second end 16. Upper end 14 is configured to include a handle 18 for grasping by a user to operate the pet waste removal device 10.

A cleaning head 21 disposed at the lower end 16 of the boom 12 includes a shield or plenum 20 connected to be moved with the boom. The plenum 20 has an open bottom 22 and an open interior space 24 defined by sidewall 26. Open bottom 22 is positioned to be generally directed away from the upper end 14 of the boom 12. Plenum 20 is placed over a pile of pet waste and the device 10 is operated to sanitize and wash away the pet waste, as will be discussed further below.

Cleaning head 21, further includes one or more nozzles 28 provide jets or sprays of treatment solution for breaking up and flushing away the pet waste. One or more nozzles 28 are disposed and arranged to direct a jet of fluid or water in a generally downwardly direction towards the open bottom 22 of the plenum 20. The one or more nozzles 28 can be arranged to provide a crossing pattern of jets to impinge upon the pet waste at different angles to further aid in breaking up the waste. Further, one or more nozzles 28 can be arranged to provide jets to impinge upon the interior surface of sidewall 26 to flush waste from the sidewall. Further yet, one or more nozzles 28 can be arranged to provide jets to impinge upon the exterior surface of sidewall 26 to flush waste from the sidewall to sanitize and flush waste from the exterior surface of the sidewall.

Nozzles 28 are fluidically connected to an accumulator 30, which is further fluidically connected to a fitting 32, which may be a standard garden hose connector, by fluid carrying conduit 34. Accumulator 30 extends transversely across lower end 16 of boom 12. Conduit 34 carries supply water from a pressurized supply of water which may be a garden hose connected to a water spigot. Conduit 34 may be integrally formed with boom 12, or may be a ridge or flexible pipe or hose extending along and within the interior or along the exterior of boom 12. Valve 36 controls the flow of supply water through conduit 34 provided via fitting 32. Valve 36 may be a normal-closed valve and spring biased into the closed position. A trigger 38 is operatively connected to valve 36, and is graspable by the fingers of a user holding handle 18, whereby valve 36 is operated by squeezing ones hand.

Cleaning head 21 further includes, an agitator 40 is disposed within the interior space 24 of the plenum 20 and is operatively connected via shaft 42 to an agitator driving assembly 44. Agitator driving assembly 44 operates to reciprocate agitator 40 in a generally vertical up-and-down direction. Agitator driving assembly 44 includes an electric motor 46 operatively connected to shaft 42 for effecting reciprocation of agitator 40. One skilled in the art will readily recognize numerous different constructs that are suitable to operatively connect electric motor 46 to shaft 42 for reciprocating shaft 42, and thus agitator 40. Unlike prior devices which include high speed rotating cutting blades, the vertical reciprocation of agitator 40 is sufficient to mechanically break up pet waste without thrashing vegetation, such as an under laying lawn, or without damaging the underlying ground surface.

In a non-limiting example, motor 46 may be operatively connected to shaft 42 by a drive arrangement including a vertically positioned drive shaft having an intermediately located disc that is angled relative to the drive shaft such that when the drive shaft rotates the disc nutates. A peripheral edge of the disc is positioned between a pair of spaced projections extending from shaft 42, thus the nutating motion of the disc is translated into an up-and-down reciprocation motion of shaft 42. Motor 46 and shaft 42 are supported by housing 48 that is operatively supported by boom 12 above plenum 20 for positioning between an upper most vertical position, as shown, and a lower most position to adjust the height of agitator 40.

A plate 50 of open mesh grating extends across the open bottom 22 of plenum 20. The open mesh grating plate 50 prevents large solid objects from entering the interior space 24 of the plenum 20 that could possibly damage the agitator 40. The mesh size of plate 50 is sufficient to permit the passage of pet waste into the interior space 24 without mashing the pet waste into the ground. Plate 24 can be removably attached to the plenum 20 by mutual engagement between periphery of the plate and sidewall 26 of the plenum.

Further included is a chemical dispenser 52 including a fluid tank 54 for holding a quantity of fluid disinfectant and/or deodorizer to be admixed with supply water flowing through fluid conduit 34 to be dispensed from nozzles 28. Tank 54 is fluidically connected at an upper end thereof to conduit 34 to receive supply water therefrom for filling the tank. Diverter valve 56 placed across conduit 34 is operated to direct water flowing therethrough into tank 54 for filling. Diverter valve 56 is a two-position valve permitting water to flow either into tank 54 or through conduit 34. Tank 54 is fitted with an internal floating ball check valve 58 to stop the flow of water into the tank once the tank is filled to capacity. A siphon tube 60 fluidically connects tank 54 at a lower end thereof to fluid conduit 34 for dispensing chemical solution contained within tank 54 for admixing with supply water flowing through conduit 34. The flow of chemical solution through siphon tube 60 is controlled by valve 62, such as an electrically operated solenoid valve. The volume or quantity of chemical solution flowing through siphon tube 60 to be admixed with supply water is controlled by proportioning or regulator valve 64. Tank 54 further includes a drain 55 for emptying the contents of the tank, an opening 57 for filling the tank with a chemical concentrate, and a discharge strainer 59 for filtering fluid flowing into siphon tube 60.

A power supply 66, such as batteries are located in battery housing 68. Alternatively, the power supply 66 could be in the form of a single battery pack containing one or more batteries, could be in the form of electrical energy provided by a power cord plugged into a powered electrical outlet, or could be in the form of a fuel cell.

In an aspect, the motor 46 is electrically connected to the power supply 66 and operated by combination of a first electrical switch 70 and a second electrical switch 72. Electrical switch 72 being conjointly operated with diverter valve 56, and being in the open or “off” state when diverter valve 56 is operated for filling tank 54, and in the closed or “on” state when diverter valve is operated for the flow of water through conduit 34. For ease of operation, switch 70 can be disposed to be conjointly operated with valve 36. For example, the trigger 38 of the valve 36 could be caused to press against and operate switch 70. In this configuration switch 70 may be a normally-closed momentary push button switch. In an aspect, solenoid valve 62 is electrically connected to the power supply 66 and operated by a combination of electrical switch 72, a third electrical switch 74 and a fourth electrical switch 76. Electrical switch 76 is a master pump switch, having “on” and “off” positions. Electrical switch 74 will operate the pump solenoid valve 62 when electrical switch 72 and electric switch 76 is in the “on” position, and will not operate valve 62 when either electrical switch 72 or electrical switch 76 is in the “off” position. Electrical switch 74 can be disposed to be conjointly operated with valve 36 in a similar manner as electrical switch 70. To this end, device 10 can be operated without dispensing a chemical solution from tank 54. Alternatives are possible, for example, electrical switches 70 and 74 can be combined into a single switch. In yet another alternative, electrical switches 72, 74, and 76 can be replaced with a dial selector having several selectable modes of operation that are controlled solely by electrical switch 70.

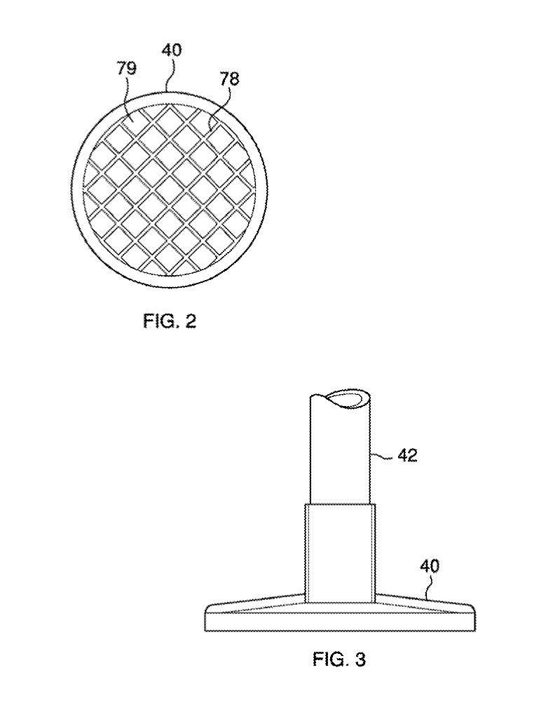

FIG. 2 is a diagrammatic bottom view of agitator 40. Agitator 40 includes an open mesh grid 78 with openings 79 extending vertically through the grid. In operation, pet waste is mechanically broken upon into smaller bits by a mashing action provided by the openings and the vertical reciprocation of the agitator 40. Jets of treatment solution from nozzles 28 are free to pass through openings the openings of the open mesh grid 78 to sanitize and flush waste from the openings and to further churn and breakup the waste.

FIG. 3 is a diagrammatic side view of agitator 40 and shaft 42. In an embodiment, shaft 42 is disposed within a collar extending from an upper surface of the agitator 40.

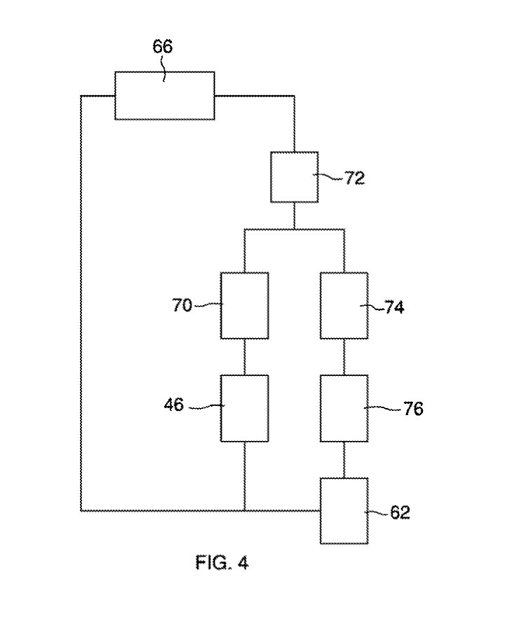

FIG. 4 is a block diagram of an electrical circuit comprising power supply 66, motor 46, solenoid valve 62, and switches 70, 72, 74, 76.

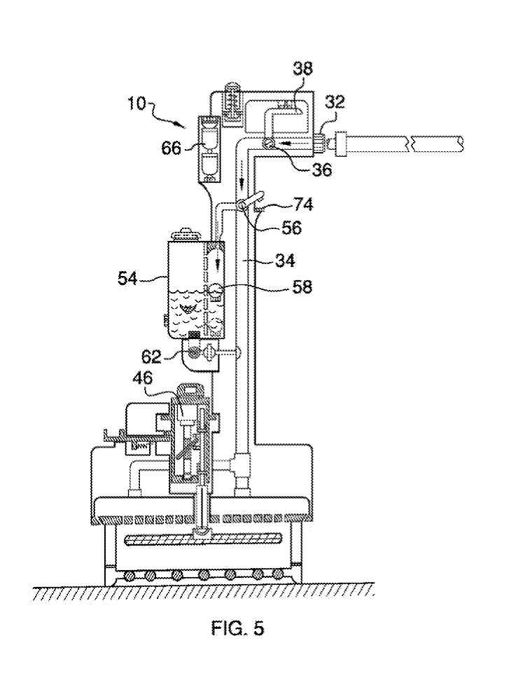

In operation, it can now be understood, the operator initially opens the lid on tank 56 to deposit environmentally friendly treatment concentrate into the tank after which the lid is securely closed. If not already connected, a water hose from source of pressurized water is securely connected to the water hose coupler 32 to establish fluid communication to fluid conduit 34. To make concentrate solution available for dispensing. The refill lever or diverter valve 56 is operated to divert fluid flow in conduit 34 to tank 54 and to operate electrical switch 74 to the “open” or off position and thus disconnect solenoid valve 62 and motor 46 from the power supply 66. The operator then pulls the trigger 38 to open water supply valve 36 allowing water under pressure to rush down the supply conduit 34 to be diverted by already positioned diverter valve 56 into tank 54, as best seen in FIG. 5. The diverted water mixes with already deposited concentrate of either solid or liquid to form a concentrate solution. Once tank 54 is filled floating ball check valve 58 prevents further filling of tank 54.

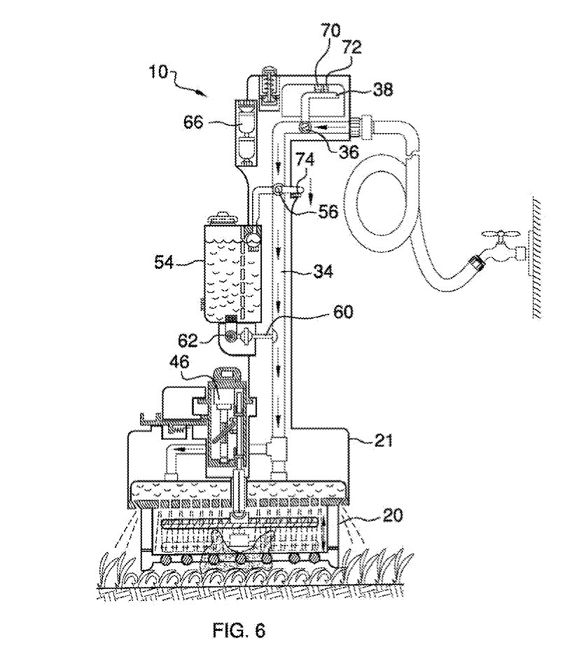

Having filled the tank 54, diverter valve 56 is returned to its normal operating position closing switch 74 which reconnects the solenoid valve 62 and motor 46 to the power supply 66, and reestablishes fluid flow through conduit 34. To eliminate waste deposit the cleaning head 21 is placed over top targeted waste with the waste shielded by plenum 20. Then the trigger 38 is pulled to open water supply valve 36 and to operate switches 70 and 74. In that, from a single pull of the trigger 28 the water supply valve 56 is open to permit water to enter the device, the solenoid valve 62 is opened and the agitator 40 is put into action simultaneously. Having pulled the trigger 38 supply water flows through fluid conduit 34 and drawing in concentrate solution through siphon tube 60 to mix with fresh water inside the fluid conduit at a set or regulated proportion of suitable dose. The concentrate solution can include sanitizing, deodorizing and disintegrating ingredients and could also include desired fragrance. The combination of treatment solution jet from nozzles 28, the treatment solution and the motion of the agitator 40 works simultaneously together to dissolve confined fecal material into soluble liquid material the sanitizing ingredient of the solution kills harmful bacteria and neutralizes offensive odor associated with animal waste making the dissolved and treated waste safe for subsequent absorbent into the ground. During operation, the concentrate solution of disinfecting properties is equally discharged at the sidewall 26 of the plenum for cleaning and sanitizing the exterior surfaces as well, as best seen in FIG. 6.

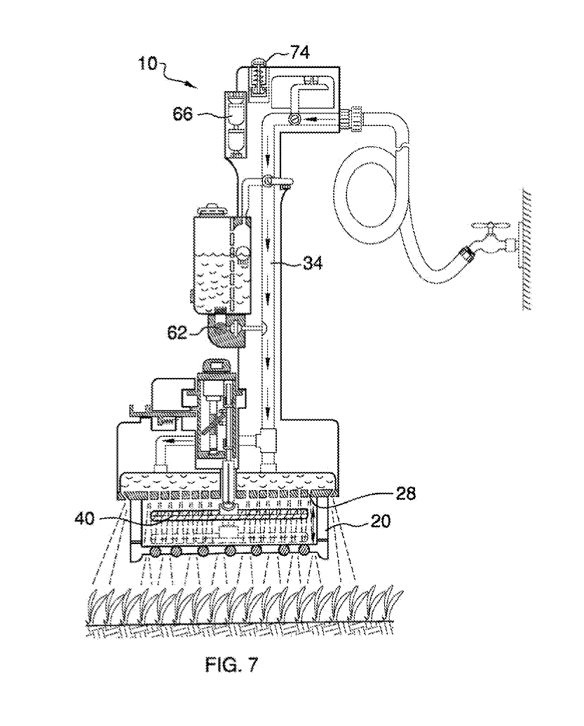

Having completely sanitized and dissolved targeted animal waste into soluble material. The operator raises the device above 10 the ground level and then operates electrical switch 74 to disconnect solenoid valve 62 from the power supply 66 to stop the dispensing of concentrate solution into the supply water flowing through fluid conduit 34, and thus initiating a self-clean mode of operation, shown in FIG. 7. During self-clean mode only fresh water is being discharged through the nozzles 28 to rinse the sanitized surfaces of the plenum 20 and agitator 40. It is equally important that the agitator 40 remain in motion during the self-clean phase to facilitate the removal and discarding of unwanted material trapped within the agitator. To this end, the device 10 is completely cleaned from all harmful bacteria and odor associated with animal waste after use

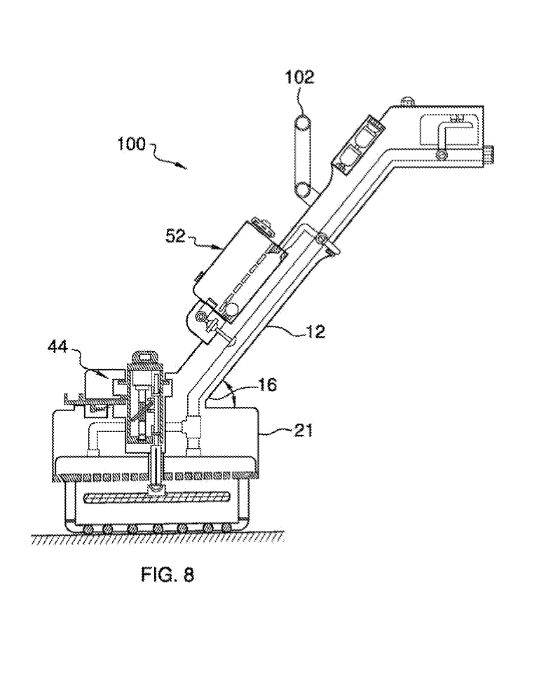

Alternative embodiments of the pet waste removal device 10 are possible. A second embodiment of the pet waste removal device 100 of the invention will be described below with reference to FIG. 8. The same reference numbers, as employed in the first embodiment, will refer to the same parts, and explanation thereof in detail will be omitted here. In the first embodiment, boom 12 is generally oriented in a vertically in relation to the horizontal or normal to the cleaning head 21 fixedly disposed at the lower end 16 of the boom. In the second embodiment 100, the boom 12 is arranged at fixed angle with respect to the cleaning head 21. Further included is an auxiliary handle 102 disposed along the boom 12 at a position between ends 14 and 16, and extending generally in an upwardly direction from the boom. Auxiliary handle 102 provides an operator with an overhand or underhand grasp to aid in the maneuvering and positioning of the pet waste removal device 100.

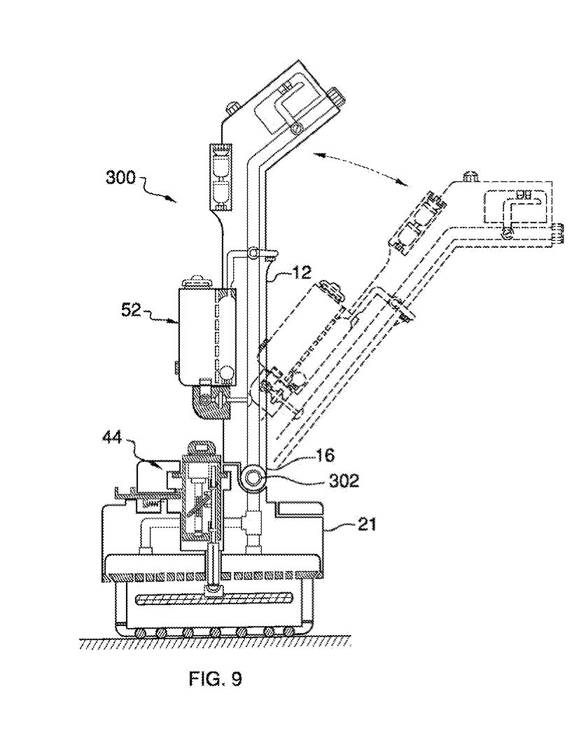

A third embodiment of the pet waste removal device 300 of the invention will be described below with reference to FIG. 9. The same reference numbers, as employed in the first embodiment, will refer to the same parts, and explanation thereof in detail will be omitted here. In the first embodiment, boom 12 is generally oriented in a vertically in relation to the horizontal or normal to the cleaning head 21 fixedly disposed at the lower end 16 of the boom. In the third embodiment 300, the boom 12 is pivotally connected to the cleaning head 21 at the lower end 16 of the boom 12 by a pivot coupling 302 for rotation between a first position where the boom is positioned generally vertical and normal to the cleaning head and a second position where the boom is positioned at an angle to the cleaning head. Pivot coupling 302 may include a locking means to prevent rotation of boom 12 once positioned as desired.

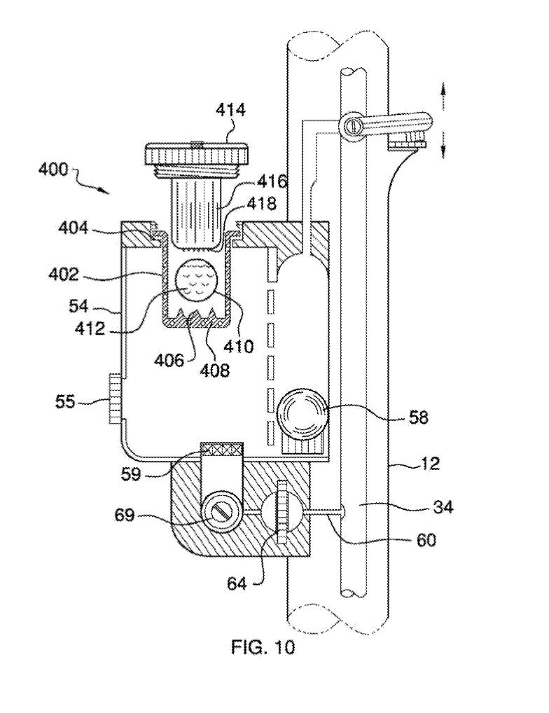

A fourth embodiment of the pet waste removal device 400 of the invention will be described below with reference to FIG. 10. The same reference numbers, as employed in the first embodiment, will refer to the same parts, and explanation thereof in detail will be omitted here. FIG. 10 is an enlarged, diagrammatic, partial cross-sectional view primary taken through concentrate holding tank 54. In this embodiment, 54 is further fitted with a removable strainer 402 extending through opening 404. Strainer 402 is fitted with sharp upwardly disposed projections 406 at a lower surface 408 thereof for piercing through a container 410 containing a quantity of concentrate solution 412. Lid 414 includes a downwardly extending muddle 416 having sharp projections 418 on a lower surface 420 thereof, likewise for piercing through container 410. Together projections 406 and 414 puncture container 410, positioned in strainer 402, as the muddle 412 compresses the container as it is inserted through opening 404 and inwardly into the strainer body 416 to release concentrate solution 412 into tank 54. Additionally shown here is drain 55, discharge strainer 59, floating ball check valve 58, solenoid valve 62, proportioning valve 64, siphon tube 60, and fluid conduit 34.

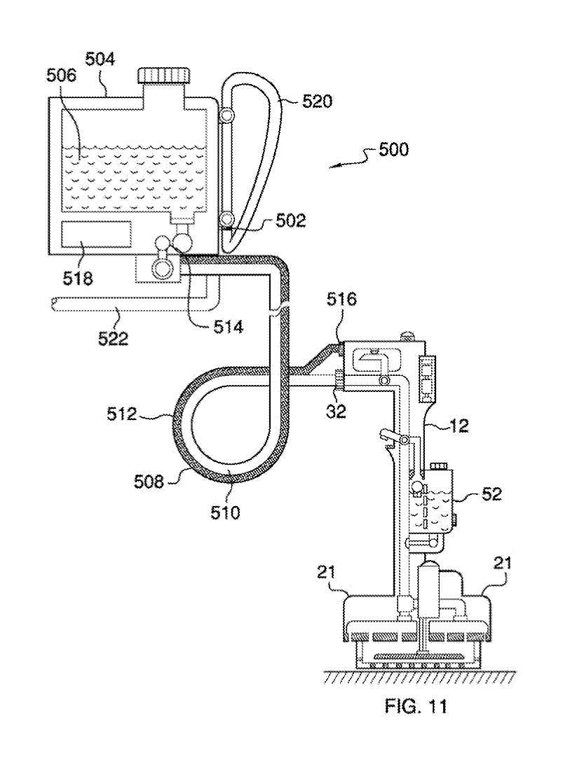

A fifth embodiment of the pet waste removal device 500 of the invention will be described below with reference to FIG. 11. The same reference numbers, as employed in the first embodiment, will refer to the same parts, and explanation thereof in detail will be omitted here. FIG. 11 is a diagrammatic, and partial cross-sectional, side elevation view of the fifth embodiment of the pet waste removal device 500. In this embodiment, the pet waste removal device 500 further includes a backpack 502 that provides a mobile source of supply water for using in removing pet waste. Backpack 502 includes supply tank 504 for holding an quantity of supply water 506. Flexible tether 508 operatively connects the backpack 502 to the boom 12, and includes a fluid hose 510, and an electric cable 512. Fluid hose 510 is connected to backpack 502 to receive supply water 506 from tank 504 by electrically operated pump 514, and is connected at the opposite end to hosing fitting 32. Pump 514 fluidically connects fluid hose 510 to tank 504 and operates to pump supply water 506 from tank 504 through hose 510 for delivery to fluid conduit 34. Electric cable 512 is connected to boom 12 by electrical communication connection 516 for transmitting a control signal to a controller, such as a relay 522, at backpack 502 for example during operation of switch 70 to connect the pump 514 to power supply 518 carried by the backpack to pump supply water 506. Backpack 502 further includes straps 520 for securing the backpack to an operators back, and a stand 522 for supporting the backpack on a ground surface when not being carried by an operator.

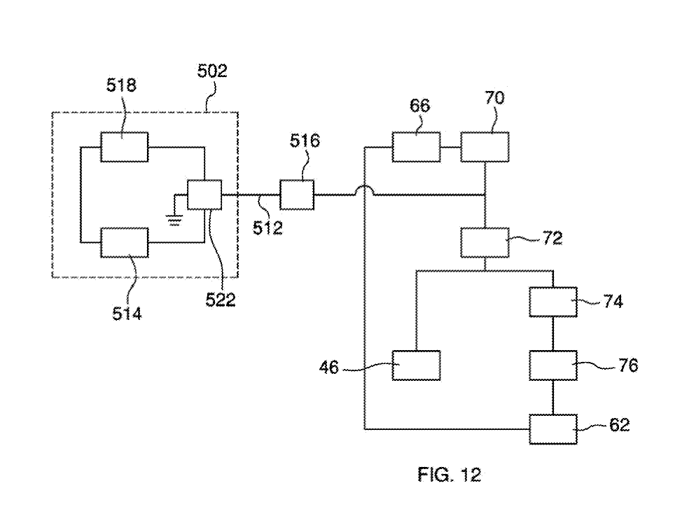

FIG. 12 is a block diagram of an exemplarily electrical circuit of the fifth embodiment of the pet waste removal device of FIG. 11

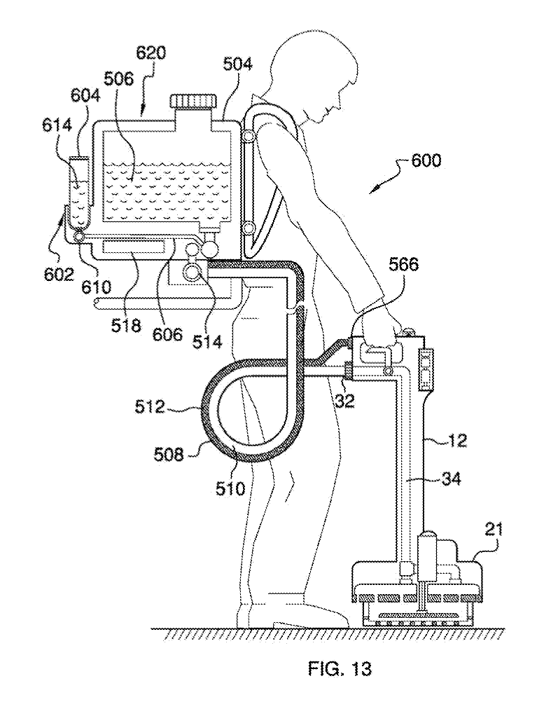

A sixth embodiment of the pet waste removal device 600 of the invention will be described below with reference to FIG. 13. The same reference numbers, as employed in the first and fifth embodiments, will refer to the same parts, and explanation thereof in detail will be omitted here. The first and fifth embodiments include a chemical dispenser 52 disposed on boom 12 for mixing a concentrate solution within tank 54 and dispensing the concentrate solution into conduit 34 for admixing with supply water flowing therethrough. In the sixth embodiment, chemical dispenser 52 is replaced with chemical dispenser 602 disposed at backpack 620, which is essentially the same as backpack 502 with the addition of chemical dispenser 602. Chemical dispenser 602 includes a container 604 of a mixed chemical solution 614 for admixing with supply water 506 stored in tank 504. Pump 514 is fluidically connected to container 604 by conduit 606 for pumping chemical solution 614 therefrom conjointly with supply water 506 from tank 504. In this manner chemical solution 614 is admix with supply water 506 during pumping. Solenoid valve 610 controls the flow of chemical solution 614 from container 604 through conduit 606, and proportioning valve 612 positioned across conduit 606 controls the amount of chemical solution that can be pumped by pump 514. Electric cable 512 is further configured to a second control signal to a controller, such as a second relay 616, at backpack 602 for example during operation of switch 74 when switch 72 is in the “on” position and switch 76 is in the “off” position to connect solenoid valve 610 to power supply 518 to permit the flow of chemical solution 614 into conduit 606 and pumping of the same by pump 514.

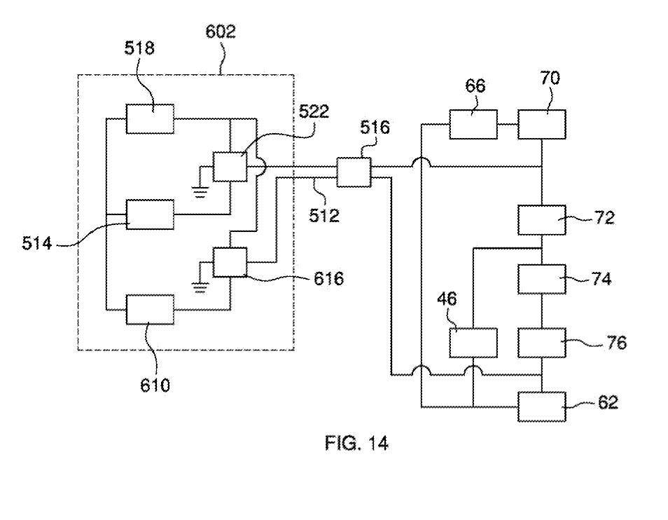

FIG. 14 is a block diagram of an exemplarily electrical circuit of the sixth embodiment of the pet waste removal device of FIG. 13.

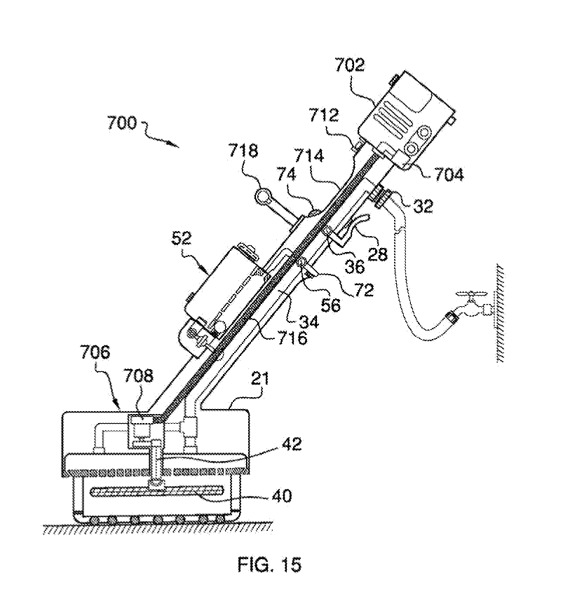

A seventh embodiment of the pet waste removal device 700 of the invention will be described below with reference to FIG. 15. The same reference numbers, as employed in the first embodiment, will refer to the same parts, and explanation thereof in detail will be omitted here. FIG. 15 is a diagrammatic, and partial cross-sectional, side elevation view of the seventh embodiment of the pet waste removal device 700. In the first embodiment, electrical power is provided to the pet waste removal device 10 by power supply 66. As discussed above, power supply 66 can be provided in the form of one or more batteries, a battery pack or an electrical cord plugged into an electrical outlet. In the seventh embodiment, power supply 66 is replaced by a combustion engine 702 drivingly coupled to an electric generator unit 704 to provide necessary electrical power to the various electrically operated components of the pet waste removal device 700. Further depicted in an alternative agitator driving assembly 706 that can be incorporated into any of the embodiments of the invention. Agitator driving assembly 706 includes electric motor 708 operatively coupled to shaft 42 by motive coupling 710 to reciprocate shaft 42. Electric cabling 716 couples motor 708 to the electrical generation 704. The pet waste removal device 700 can further include electrical communication connection 712, which is essentially the same as electrical communication connection 514 of the fifth embodiment. In this manner, the seventh embodiment can be used conjointly with the backpack 502 of the fifth embodiment in the manner described and shown with reference to the fifth and like embodiments. Further in the seventh embodiment, handle 18 has been replaced by boom grasp 714 and switches 70, 72, and 76 are correspondingly relocated as shown. Additionally, auxiliary handle 718 extends upwardly from the boom 12 and provides the operator with an additional grasp for maneuvering the device. The seventh embodiment, is configured similarly to a conventional vegetation line trimmer

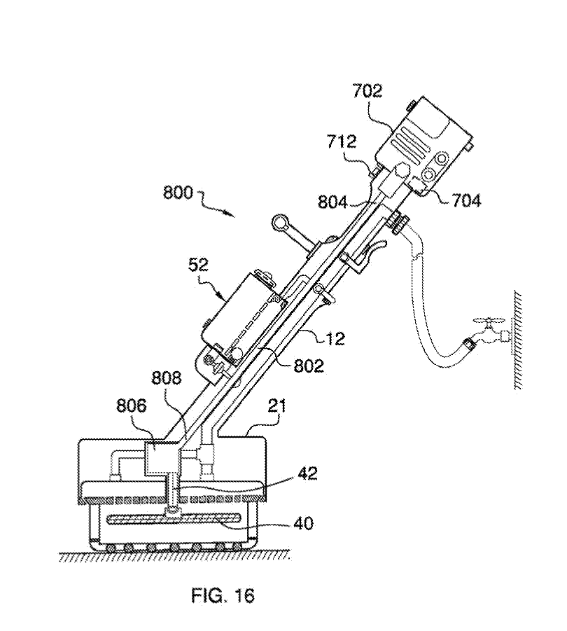

An eighth embodiment of the pet waste removal device 800 of the invention will be described below with reference to FIG. 16. The same reference numbers, as employed in the first, fifth and seventh embodiments, will refer to the same parts, and explanation thereof in detail will be omitted here. FIG. 16 is a diagrammatic, and partial cross-sectional, side elevation view of the seventh embodiment of the pet waste removal device 800. In the seventh embodiment, combustion engine 702 is provided and is driving coupled to an electric generator unit 704 to provide necessary electrical power to the various electrically operated components, including electric motor 708. In the eight embodiment, a drive shaft 802 extends the length of the boom 12 and is operatively connected to the combustion engine 702 at one end 804 to be drivingly rotated, and is operatively connected to a gear box 806 at the opposite end 808. Gear box 806 is operatively connected to shaft 42 to reciprocate the same, and thus the agitator 40. Further as in the seventh embodiment, the eighth embodiment can include electrical communication connection 712, for use conjointly with the backpack 502 of the fifth embodiment as shown and described above.

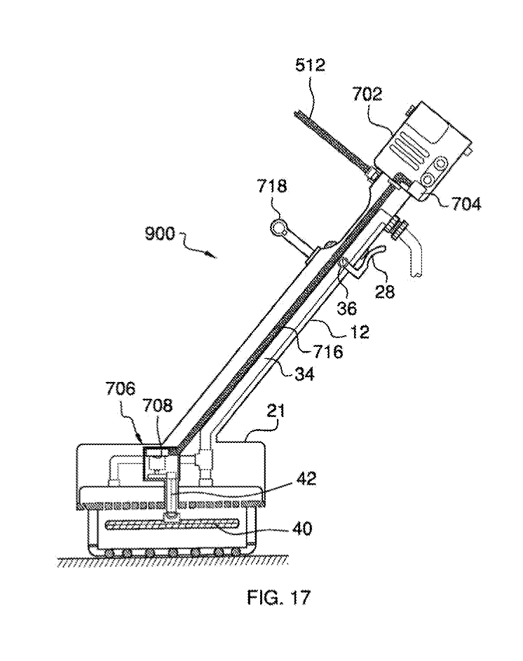

A ninth embodiment of the animal pet waste device 900 of the invention will be described below with reference to FIG. 17. The same reference numbers, as employed in above embodiments, will refer to the same parts, and explanation thereof in detail will be omitted here. FIG. 17 is a diagrammatic, and partial cross-sectional, side elevation view of the seventh embodiment of the pet waste removal device 900. The ninth embodiment combines features of the seventh and sixth embodiments. The ninth embodiment is essentially configured as the seventh embodiment, but as in the sixth embodiment it does not include chemical dispenser 52, and alternatively is configured to be used with backpack 602 as discussed and shown above.

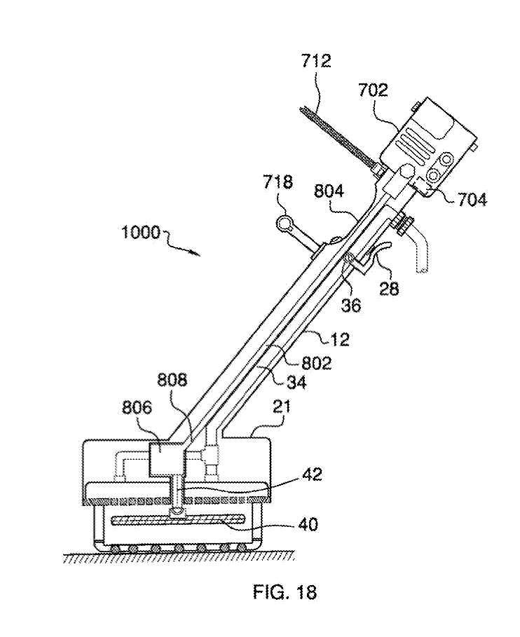

A tenth embodiment of the animal pet waste device 1000 of the invention will be described below with reference to FIG. 18. The same reference numbers, as employed in above embodiments, will refer to the same parts, and explanation thereof in detail will be omitted here. FIG. 18 is a diagrammatic, and partial cross-sectional, side elevation view of the seventh embodiment of the pet waste removal device 1000. The tenth embodiment combines features of the eighth and sixth embodiments. The tenth embodiment is essentially configured as the eight embodiment embodiment, but as in the sixth embodiment it does not include chemical dispenser 52, and alternatively is configured to be used with backpack 602 as discussed and shown above.

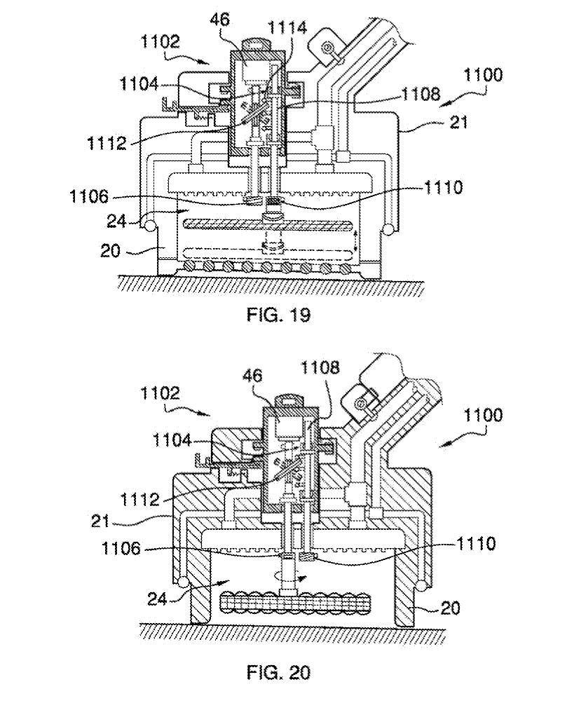

An eleventh embodiment of the animal pet waste device 1100 of the invention will be described below with reference to FIGS. 19 and 20. The same reference numbers, employed in above embodiments, will refer to the same parts, and explanation thereof in detail will be omitted here. The eleventh embodiment comprises alternative exemplary agitator driving assembly 1102 to the exemplary agitator driving assembly 44 as shown and described above with reference to the first embodiment. Agitator driving assembly 1102 includes provisions for either driving shaft 42 of the agitator in an up-and-down reciprocation motion, in a continuous rotary motion or a clockwise and counterclockwise rotary motion as desired by the operator. Agitator driving assembly 1102 includes electric motor 46 connected to drive shaft 1104 for rotatingly driving the drive shaft. Drive shaft 1104 extends from motor 46 downwardly and into the internal space 24 of plenum 20 and terminates at a threaded end 1106. Drive shaft 1104 is appropriate supported for rotation by bearings. Shaft 1108 is supported for up-and-down reciprocation parallel to rotationally driven shaft 1104, and terminates at a threaded end 1110 in the internal space 24 of the plenum. As in the exemplary agitator driving assembly 44, a disc 1112 disposed at an angle to shaft 1104 is attached to shaft 1104 for conjoint rotation therewith. The peripheral edge of disc is positioned between a pair of spaced projections 1114 on shaft 1108. Operation of electric motor 46 rotates shaft 1104 which causes disc 1112 to nutate in space, the nutation motion of the disc is translates into a reciprocation motion in shaft 1108. Agitator 40 includes a threaded couple for threading attachment to either end 1106 of shaft 1104 or threaded end 1110 of shaft 1108. As can be understood, agitator is threadably connected to shaft 1108 for use in an up-and-down reciprocation motion, FIG. 19 or is threadably attached to shaft 1104 for a continuous rotation motion, FIG. 20.

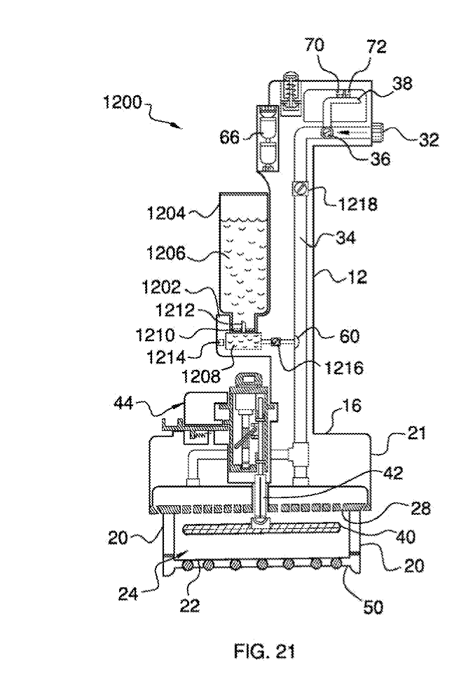

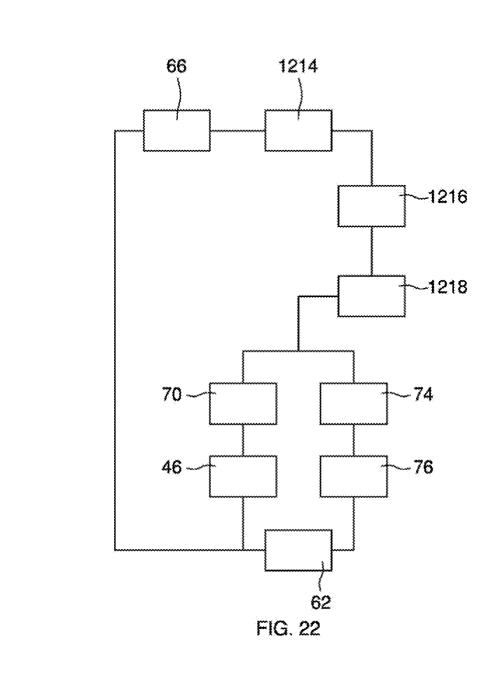

A twelfth embodiment of the animal pet waste device 1200 of the invention will be described below with reference to FIGS. 21 and 22. The same reference numbers, employed in above embodiments, will refer to the same parts, and explanation thereof in detail will be omitted here. The twelfth embodiment comprises an alternative chemical dispensing and control arrangement particularly, device 1200 includes a cradle 1202 that is adapted to removable receive and retain a container 1204 containing a quantity of chemical concentrate solution 1206. The cradle 1202 includes a fluid accumulator 1208 that is fluidically connected to the container 1204 when received by the cradle 1202 to receive chemical concentrate solution 1206 from the container. The container 1204 and the fluid accumulator 1208 may be fluidically connected, in one example, by a membrane puncture conduit 1210 that pierces through a membrane seal 1212 of the container 1204. A fluid sensor 1214 is operatively connected to the accumulator 1208 to sense a presence of solution 1206 within the accumulator. Solenoid valve 1216 is disposed across siphon tube 60 and solenoid valve 1218 is disposed across flow passage 34 upstream from the siphon tube. Valves 1216 and 1218 are operatively connected to fluid sensor 1214 and operate to close when the fluid sensor determines no presence of solution 1206 within the fluid accumulator 1208 to prevent operation of the device 1200 such that waste cannot be removed without the use of chemical solution 1206. Valves 1216 and 1218 are opened when the fluid sensor 1214 determines the accumulator 1208 contains chemical solution 1206, and thus permits operation of the device 1200.

A number of embodiments of the present invention have been described. Nevertheless, it will be understood that various modifications may be made without departing from the scope of the invention.

1. An apparatus for removing animal waste from a surface, comprising:
a boom configured to be grasped by an operator at one end;
a cleaning head attached to said boom, said cleaning head having a plenum with an open bottom, said open bottom facing in a direction away from said boom;
a material agitator disposed within said plenum;
an agitator driving assembly connect to said material agitator and operable to drive said material agitator;
a fluid passage configured to be connected to a supply of pressurized fluid;
a plurality of outlet nozzles arranged along said plenum and configured to dispense fluid flowing through said fluid passage;
a fluid dispenser fluidically connected to said fluid passage and operable to admix chemical concentrate with fluid flowing through said fluid passage; and
wherein said apparatus is operable in one mode of operation where fluid may flow through said fluid passage without chemical concentrate being admixed therewith and in a second mode of operation where chemical concentrate is admixed with fluid flowing through said flow passage.

2. The apparatus of claim 1, wherein said plurality of outlet nozzles include one or more outlet nozzle arrange within said plenum and to dispense fluid towards said open bottom.

3. The apparatus of claim 2, wherein said plurality of outlet nozzles include one or more outlet nozzle arranged exteriorly of said plenum and to dispense fluid towards said plenum.

4. The apparatus of claim 1, wherein said material agitator is driven by said agitator driving assembly for reciprocal movement in a direction towards and away from said open bottom.

5. The apparatus of claim 1, wherein said material agitator is driven by said agitator driving assembly for rotation about an axis extending through said open bottom.

6. The apparatus of claim 1, further comprising:
a main valve disposed across said fluid passage at an upstream location;
a control lever operatively connected to said main valve and operable to open or close said main valve to control the flow of fluid through said main passage, said control lever disposed to be grasped by an operator while grasping said boom;
said fluid dispenser including a container fluidically connected to said fluid passage at first connection downstream from said main valve to be filled by fluid flowing through said fluid passage to form a concentrate chemical solution therein, said fluid dispenser further including a siphon tube fluidically connecting said container at a second connection downstream from said first connection, wherein fluid flowing through said fluid passage and across said siphon tube draws chemical solution from said container and through said siphon tube and into said fluid passage where it is admixed with the fluid flowing through said fluid passage and connected to said fluid passage at a downstream end to dispense said concentrate chemical solution into said fluid passage; and
said fluid dispenser include a valve operable to seal said container from said fluid passage at said first connection as a function of the fill level of said container.

7. The apparatus of claim 6, said valve comprises a ball float.

8. The apparatus of claim 1, wherein said agitator driving assembly is configured to either drive said material agitator in a reciprocal movement in a direction towards an away from said open bottom or to drive said material agitator for rotation about an axis extending through said open bottom.

9. The apparatus of claim 1, wherein said fluid passage extends along said boom.

10. The apparatus of claim 1, wherein said fluid dispenser is fluidically connected to said fluid passage at an upstream location to receive fluid flowing through said fluid passage to form a concentrate chemical solution, and connected to said fluid passage at a downstream end to dispense said concentrate chemical solution into said fluid passage.

11. The apparatus of claim 10, wherein said fluid dispenser includes a container fluidically connected to said fluid passage at said upstream location and further includes a valve operable to seal said container from said fluid passage at said upstream location.

12. The apparatus of claim 11, wherein said valve comprises a ball float.

13. The apparatus of claim 1, wherein said agitator driving assembly includes an electric motor and said apparatus further includes a power supply connectable to said electric motor to provide electrical power to operate said electric motor.

14. The apparatus of claim 13, wherein said power supply comprises a combustion engine driving electrical generator.

15. The apparatus of claim 1 further comprising:
a open mesh grate extending across said open bottom.

16. The apparatus of claim 1, wherein said cleaning head is fixedly connected to said boom.

17. The apparatus of claim 1, wherein said cleaning head is pivotally connected to said boom.

18. The apparatus of claim 1, further comprising:
a fluid reservoir configured to be carried on the back of an operator;
said fluid reservoir fluidically connected to said fluid passage; and
a pump operable to pump fluid contained by said fluid reservoir through said fluid passage under pressure.

19. The apparatus of claim 1, further comprising:
a combustion engine;
a drive shaft connected to said combustion engine to be rotatingly driven; and
said drive shaft operatively connected to said material agitator to drive said material agitator.

20. The apparatus of claim 11, wherein said fluid dispenser includes a siphon tube fluidically connecting said container with said fluid passage at said downstream location, and wherein fluid flowing through said fluid passage and across said siphon tube draws chemical solution from said container and through said siphon tube and into said fluid passage where it is admixed with the fluid flowing through said fluid passage.

21. The apparatus of claim 1, wherein:
said boom includes a cradle and a fluid accumulator;
said fluid dispenser includes a container that is removably receivable by said cradle to be in fluidic communication with said fluid accumulator;
said apparatus further including:
a fluid sensor disposed to detect fluid within said fluid accumulator; and
at least one valve across said fluid passage that is operable to close upon said fluid sensor detecting no fluid within said fluid accumulator.

22. The apparatus of claim 21, wherein said fluid dispenser includes a siphon tube fluidically connecting said fluid accumulator with said fluid passage at downstream location from said at least one valve, and wherein fluid flowing through said fluid passage and across said siphon tube draws chemical solution from said container and through said siphon tube and into said fluid passage where it is admixed with the fluid flowing through said fluid passage.

23. The apparatus of claim 21, wherein said plurality of outlet nozzles include one or more outlet nozzle arrange within said plenum and to dispense fluid towards said open bottom.

24. The apparatus of claim 23, wherein said plurality of outlet nozzles include one or more outlet nozzle arranged exteriorly of said plenum and to dispense fluid towards said plenum.

25. The apparatus of claim 21, wherein said material agitator is driven by said agitator driving assembly for reciprocal movement in a direction towards and away from said open bottom.
